(19) United States
(12) Patent Application Publication
(10) Pub. No.: US 2010/0226735 A1
(43) Pub. Date: Sep. 9, 2010

(54) APPARATUS AND METHOD FOR BINDING SHEETS

(76) Inventors: Colin Knight, Winnetka, IL (US); Timothy K. Nowack, Des Plaines, IL (US)

Correspondence Address: MICHAEL BEST & FRIEDRICH LLP, 100 E WISCONSIN AVENUE, Suite 3300, MILWAUKEE, WI, 53202, US

(21) Appl. No.: 12/399,419

(22) Filed: Mar. 6, 2009

(51) Int. Cl. B42C 5/00; B42B 5/00

(52) U.S. Cl. 412/6; 412/33

(57) ABSTRACT

A binding spine for binding together stacks of sheets. The binding spine includes a first member, a second member spaced from the first member, and a connector connecting the first member and the second member to define a preliminary stack insertion gap therebetween prior to binding. The connector allows the first member and the second member to be collapsed toward each other to define a final gap therebetween that is less than the preliminary stack insertion gap.

### BACKGROUND

The present invention relates to binding machines for binding sheets, binding spines for use with binding machines, and methods for binding sheets using the same.

Binding machines most typically perform a punching operation on a stack of sheets prior to performing a binding operation. The binding operation may include the insertion of one or more binding elements (i.e., rings, spiral cord, etc.) into the punched holes. Some binding machines are known, which do not require pre-punching and which may also use staples or staple-like binding elements to bind the sheets. Binding spines for use with such binding machines are generally formed in multiple pieces to accommodate for binding stacks of different thicknesses or are alternately formed as a single piece, which is only appropriate for use with a stack of sheets having thickness within a small predetermined range.

### SUMMARY

In one embodiment, the invention provides a binding spine having multiple configurations for binding together stacks of sheets. The binding spine includes a first member, a second member spaced from the first member, and a connector connecting the first member and the second member to define a preliminary stack insertion gap therebetween prior to binding. The connector allows the first member and the second member to be collapsed toward each other to define a final gap therebetween that is less than the preliminary stack insertion gap.

In another embodiment, the invention provides a binding spine for binding together stacks of sheets. The binding spine includes a first member, a second member spaced from the first member, and a collapsible connector adjustably connecting the first member and the second member. The collapsible connector biases the binding spine to a first configuration in which the first member and the second member are spaced a first distance apart to define a preliminary stack insertion gap therebetween prior to binding. The collapsible connector is deformable such that the binding spine assumes a second configuration in which the first member and the second member are spaced apart a second distance after binding to define a final gap therebetween that is less than the preliminary stack insertion gap.

In yet another embodiment, the invention provides a method of binding a stack of sheets with a binding spine. A binding spine is provided including a first member, a second member, the first and second members being interconnected by a connector. A predetermined stack insertion gap is provided between the first member and the second member with the connector. A stack of sheets is inserted into the stack insertion gap. The first member and the second member are collapsed toward each other. The stack of sheets is clamped between the first member and the second member. A binding element is inserted through the stack of sheets and at least partially through each of the first member and the second member to bind the stack of sheets in the binding spine.

In yet another embodiment, the invention provides a binding machine including three stapling heads arranged in a row and operable independently from each other and a base to which each of the stapling heads is pivotably coupled. Three anvils are coupled to the base and correspond to the three stapling heads, the three anvils being arranged in a row and each aligned with a staple-ejecting portion of the corresponding stapling head. A throat area is common to the three stapling heads and configured to receive a binding spine and a stack of sheets to be bound.

Other aspects of the invention will become apparent by consideration of the detailed description and accompanying drawings.

### BRIEF DESCRIPTION OF THE DRAWINGS

FIG. 1 is a perspective view of a binding machine embodying the invention.

FIG. 2 is a front view of the binding machine of FIG. 1.

FIG. 3 is a side view of the binding machine of FIG. 1 having a binding spine embodying the invention positioned therein.

FIG. 4 is a perspective view of an anvil portion of the binding machine of FIG. 1. The binding spine is positioned in the binding machine as in FIG. 3.

FIG. 5 is a perspective view of a binding spine for use with the binding machine of FIG. 1.

FIG. 6 is a front view of the binding spine of FIG. 5.

FIG. 7 is an end view of the binding spine of FIG. 5.

FIG. 8 is a top view of the binding spine of FIG. 5.

FIG. 9 is a perspective view of the binding machine of FIG. 1 having a stack of sheets to be bound inserted therein with the binding spine of FIG. 5, ready for binding.

FIG. 10 is a cross-sectional view of the binding machine, taken along line 10-10 of FIG. 9.

FIG. 11A is a cross-sectional view of the binding machine also taken along line 10-10 of FIG. 9, illustrating an initial step in a binding operation prior to binding.

FIG. 11B is a cross-sectional view of the binding machine also taken along line 10-10 of FIG. 9, illustrating a further step in the binding operation just prior to binding.

FIG. 12 is a cross-sectional view of the binding machine also taken along line 10-10 of FIG. 9, illustrating the stack of sheets immediately after completion of the binding operation.

FIG. 13 is a perspective view of the bound stack of sheets of FIG. 12.

FIG. 14 is a partial rear perspective view of the bound stack of sheets of FIGS. 12 and 13, illustrating staple legs engaging a lower spine member.

FIG. 15 is cross-sectional view of a binding spine having means for positioning the binding spine relative to a binding machine that is separate from a means connecting upper and lower members of the binding spine together.

FIG. 16 is a cross-sectional view of a binding spine having a predetermined breaking location at which first and second members of the binding spine are separated from each other and at which a positioning member is separated from the first and second members.

FIG. 17 is a perspective view of an alternate binding machine embodying the invention.

FIG. 18 is a perspective view of an alternate binding spine for use with the binding machine of FIG. 17.

FIG. 19 is an alternate perspective view of the binding spine of FIG. 18.

FIG. 20 is a front view of the binding spine of FIG. 18.

FIG. 21 is an end view of the binding spine of FIG. 18.

FIG. 22 is a perspective view of the binding machine of FIG. 17 having the binding spine of FIGS. 18-21 inserted therein.

FIG. 23 is a rear view of the spine of FIGS. 18-21 with a stack of sheets inserted therein, illustrating exemplary collapse of the binding spine.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

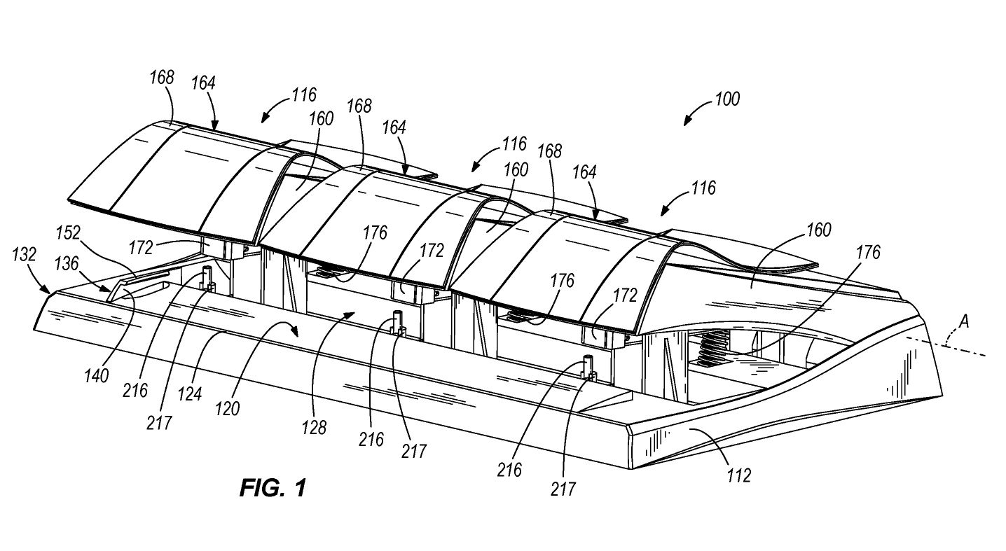

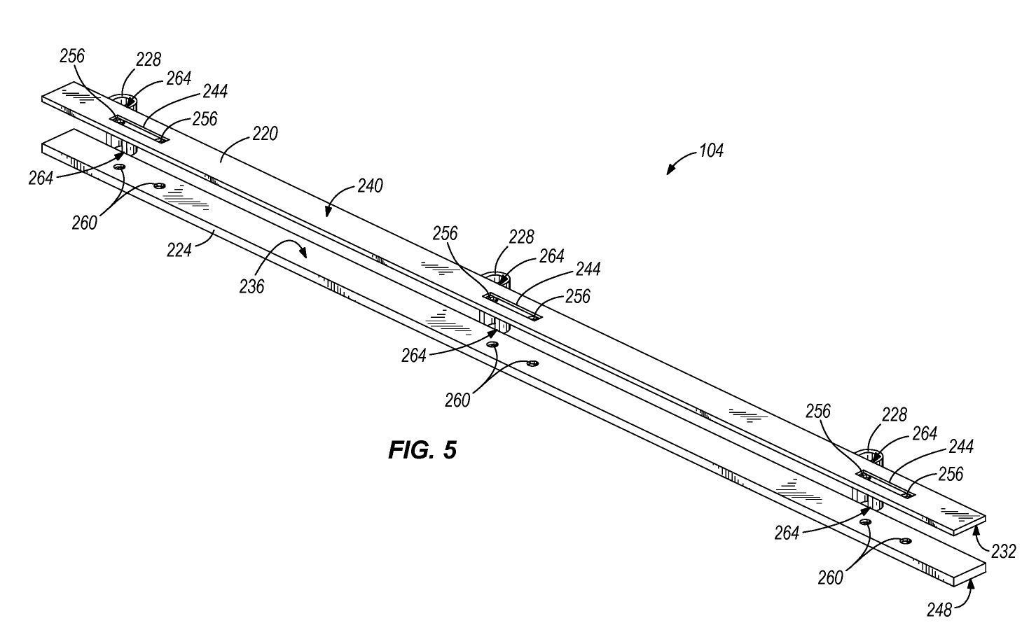

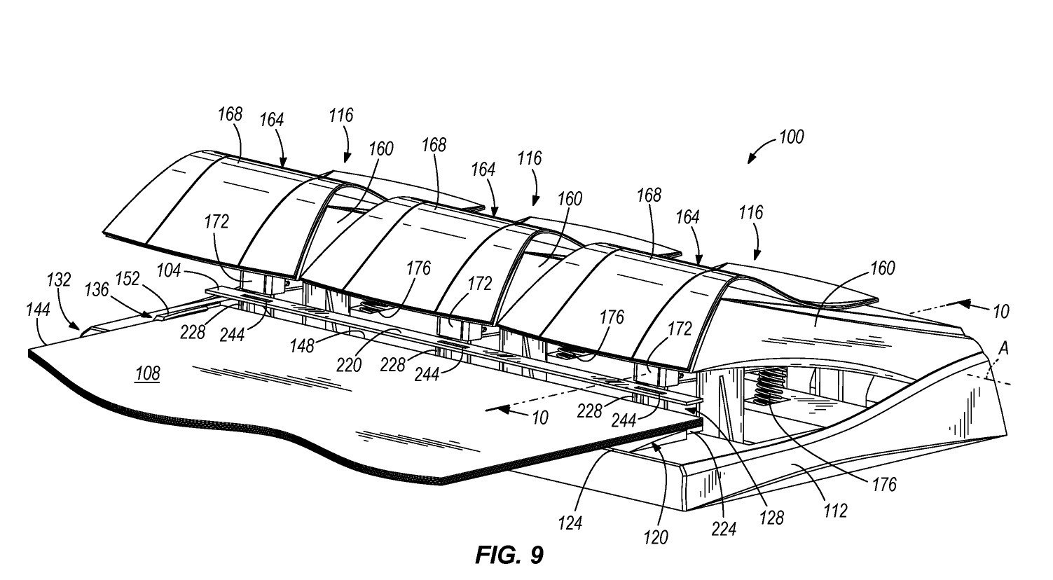

FIG. 1 illustrates a binding machine 100 for use with a binding spine 104 (FIG. 5) to bind a stack of sheets 108 (FIGS. 9-14). The binding machine 100 includes a base 112 and three binding units (i.e., stapling heads 116), each independently and pivotably coupled to the base 112. In alternate constructions, the stapling heads 116 may be coupled together, made at least partially integral with each other, and/or unitarily actuable. Although specific reference is made to the use of staples, other binding elements (e.g., nails, rivets, clips, etc.) may also be used with appropriate binding units of other types. Furthermore, other embodiments may include two stapling heads 116 or more than three stapling heads 116. The base 112 includes a support surface 120 configured to support a stack of sheets (of paper or another material) that are to be bound. The illustrated support surface 120 is ramped upwardly from a front edge 124 thereof towards a throat area 128 of the binding machine 100.

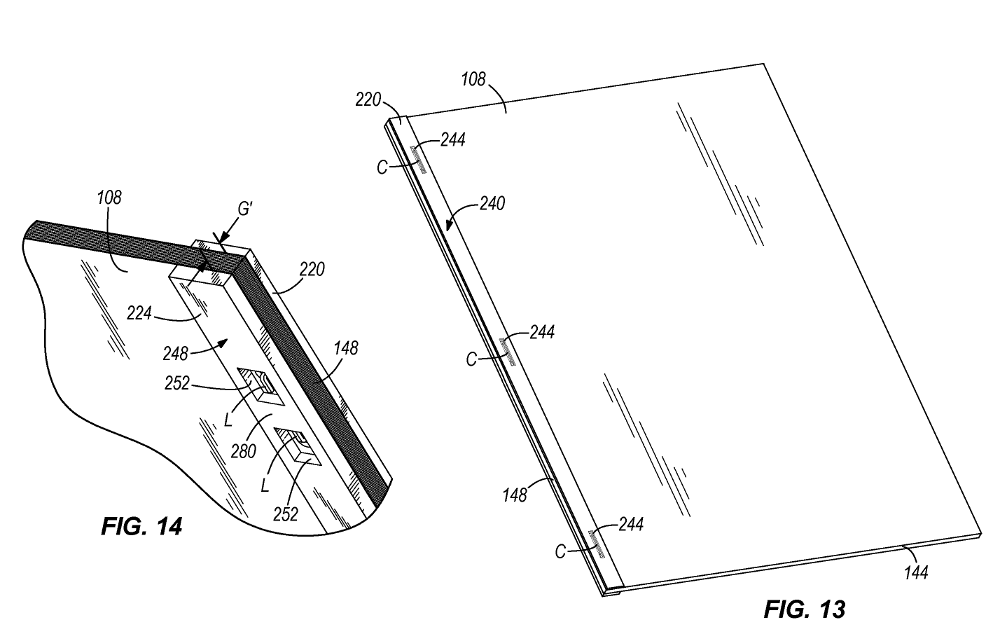

Adjacent a first end 132 of the binding machine 100, a paper guide 136 provides an abutment or contact surface 140 for aligning sheets within the stack of sheets 108 along a first edge 144 (FIG. 13) thereof that is adjacent and substantially perpendicular to an edge 148 (FIG. 13) that is intended to be bound. The paper guide 136 further includes an upper wing 152 extending substantially perpendicular from the abutment surface 140. The upper wing 152, together with the support surface 120, provides a constraint for limiting the amount of sheets that may be inserted into the binding spine 104 and, thus into the binding machine 100. Due to the upward ramping of the support surface 120, the sheets within the stack of sheets 108 are compressed, if necessary, by the support surface 120 and the upper wing 152 just prior to entry into the throat area 128 of the binding machine 100. In some constructions, the upper wing 152 is also ramped towards the throat area 128 (oppositely of the support surface 120) such that the maximum gap between the upper wing 152 and the support surface 120 is even larger. It will also be appreciated that the upper wing 152 is ramped instead of the support surface 120 in some constructions to provide a similar function.

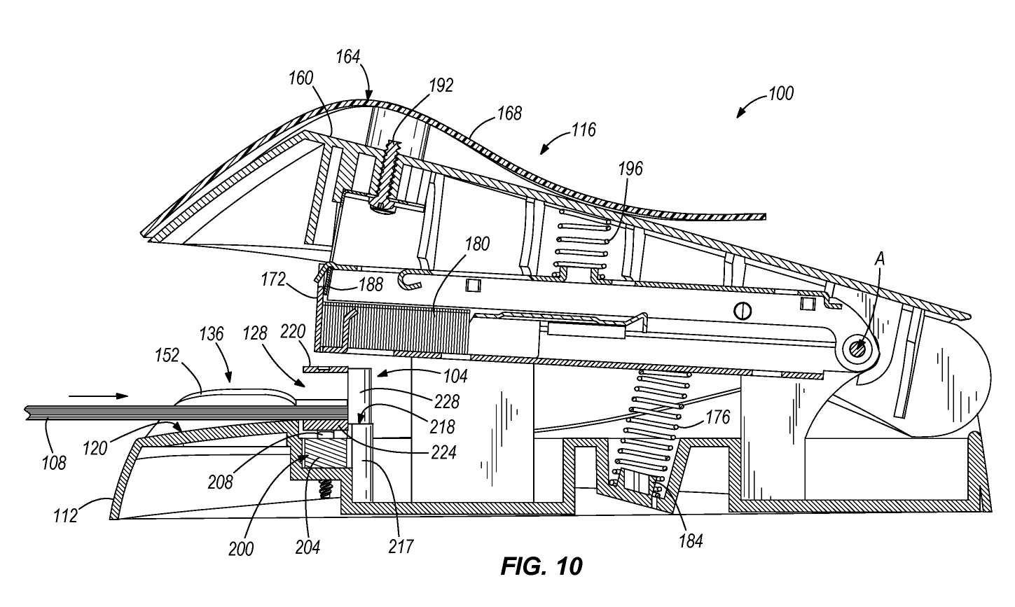

The three stapling heads 116 are substantially similar in construction and operation. Each stapling head 116 includes an input member 160 operable to receive an input force from a user. Furthermore, an ergonomic user contact surface 164 is provided for direct operation by a user. As shown in FIGS. 10-12, the user contact surface 164 is provided as part of a separate user contact member 168, which is coupled to the input member 160 so that the input member 160 and the user contact member 168 move together during operation. The input member 160 is pivotably coupled to the base 112 at a pivot axis A.

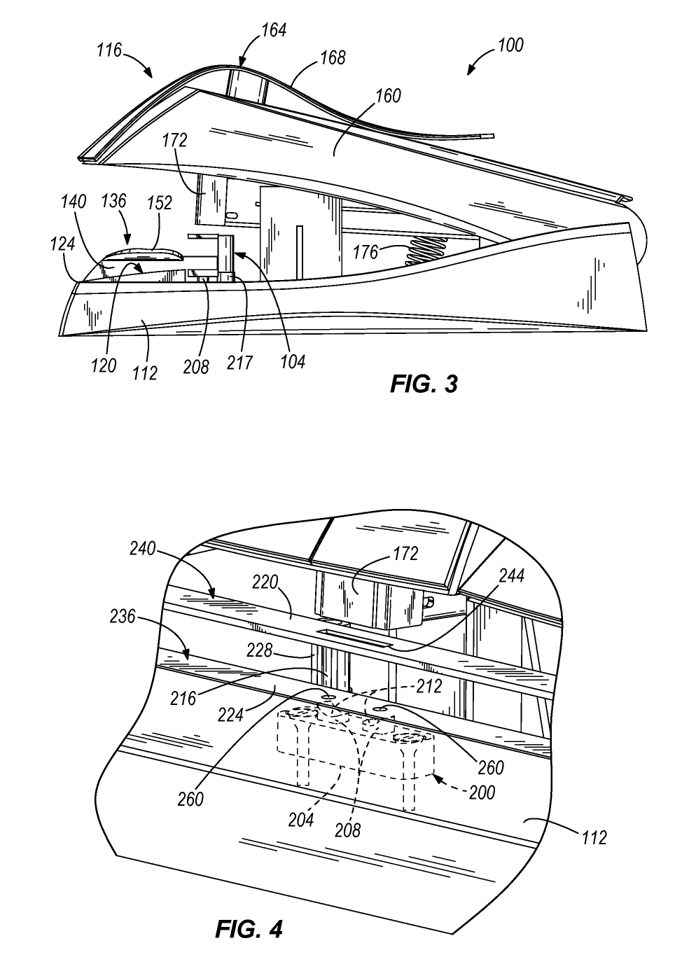

Each stapling head 116 includes a magazine 172 configured to store a strip of staples 180. The magazine 172 is pivotably coupled to the base 112 at the pivot axis A. A first spring 176 located underneath the magazine 172 and retained on a boss 184 of the base 112 biases the magazine 172 in a generally upward direction to a non-actuated position (FIGS. 1-4 and 9-10). Each stapling head 116 is pivotable upwardly away from the base 112 to enable insertion of the binding spine 104. Additionally, the input member 160 and the contact member 168 are pivotable upwardly away from the magazine 172 to enable insertion of the strip of staples 180 into the magazine 172. In an alternate construction, the magazine 172 is of the front-loading type, and the strip of staples 180 is insertable into the magazine 172 without lifting the input member 160 and/or contact member 168 off of the magazine 172.

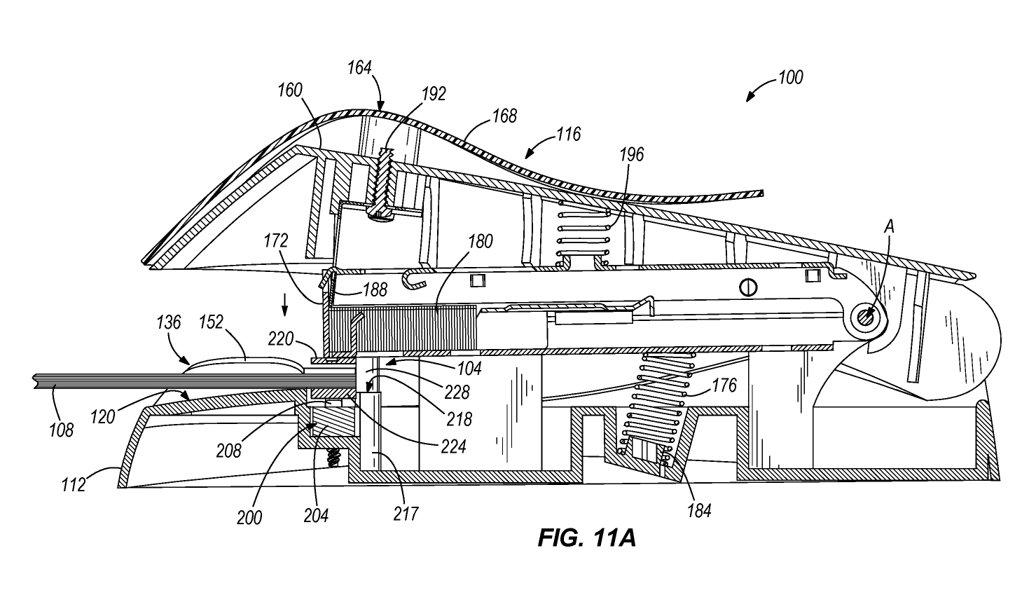

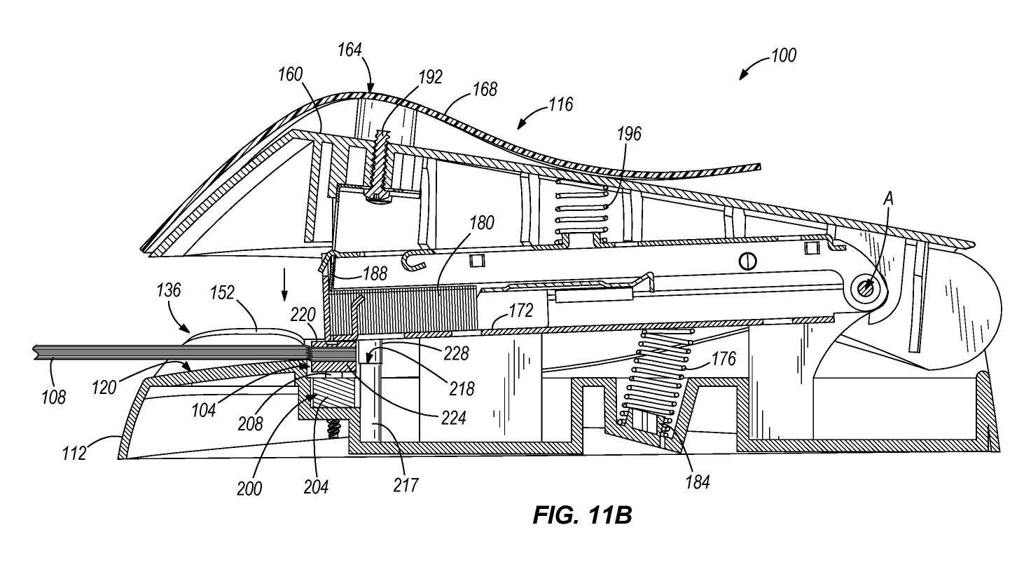

A driver blade 188 is coupled to the input member 160 as shown in FIGS. 10-12. In the illustrated construction, the driver blade 188 is directly coupled to the input member 160 with a fastener 192 (e.g., a screw). The driver blade 188 is positioned above a forwardmost staple 180 in the non-actuated position such that the driver blade 188 is in position to eject the forwardmost staple 180 from the magazine 172 upon actuation of the input member 160. A second spring 196 is positioned between the input member 160 and the magazine 172 to resist movement of the input member 160 relative to the magazine 172 until after the magazine 172 is moved into an actuated position (FIG. 11A) in which the first spring 176 is at least partially compressed. Thus, the biasing force of the second spring 196 is more difficult to overcome than that of the first spring 176. The difficulty in overcoming the biasing force of either of the first or second springs 176, 196 is dependent upon the spring coefficient, the position of the spring relative to the pivot axis A, and the position of the applied force.

As best seen in FIG. 4, the binding machine 100 includes an anvil 200 corresponding to each one of the stapling heads 116. Each anvil 200 is coupled to the base 112 at a location below the forwardmost end of the respective magazines 172. The anvils 200 each include an anvil base 204 and a pair of anvil blocks 208. Each of the anvil blocks 208 extends upwardly from the anvil base 204 and includes a curved anvil surface 212 configured to engage one leg L of a staple 180 after the staple 180 is ejected from the respective stapling head 116 and driven through the stack of sheets 108.

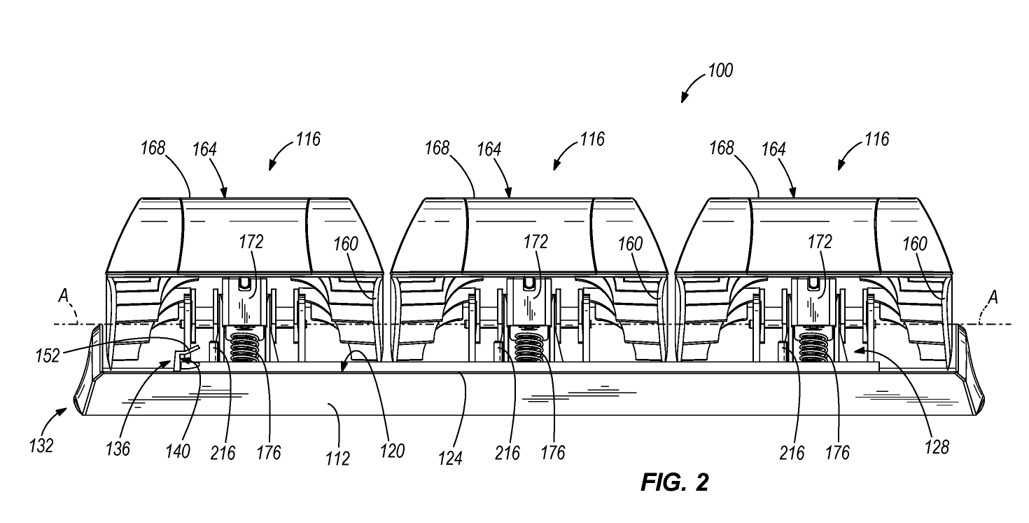

As shown in FIGS. 1 and 2, the binding machine 100 includes three alignment features in the form of male members or posts 216, each extending from a support block 217 (FIG. 10) of the base 112. The illustrated posts 216 are generally vertically oriented. Each post 216 is positioned within the throat area 128 and adjacent a respective one of the stapling heads 116. The posts 216 are configured to engage the binding spine 104 as described in further detail below. Each support block 217 includes an upper surface 218 configured to support the binding spine 104 from below.

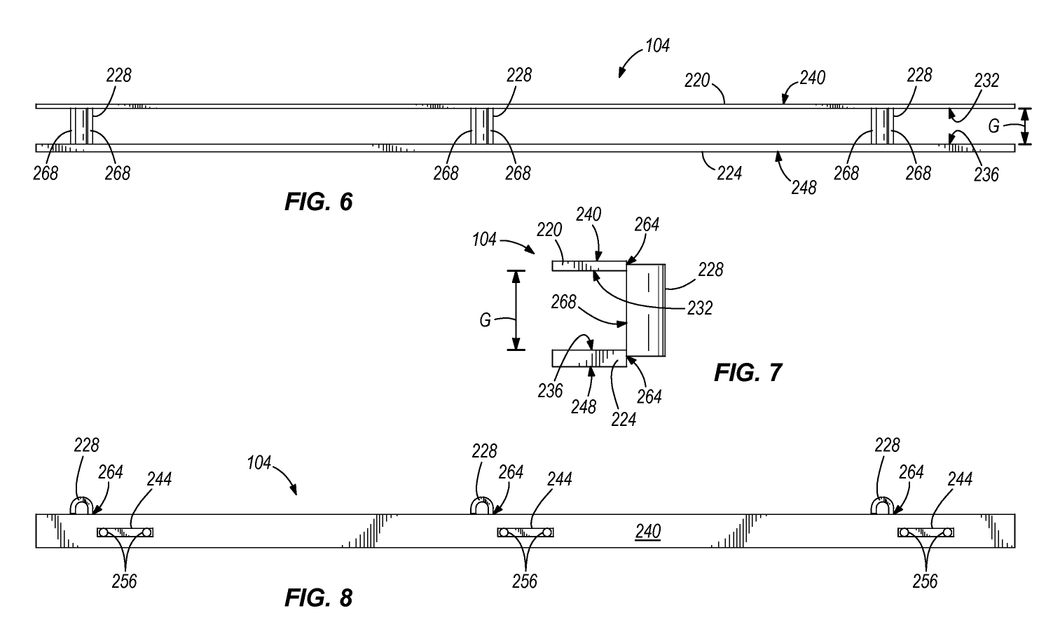

The binding spine 104 is illustrated in detail in FIGS. 5-8. The binding spine 104 includes a first member (“upper member 220”), a second member (“the lower member 224”), and three temporary connectors 228. The upper member 220 is generally planar and is configured to lie against a top sheet of the stack of sheets 108 when bound. The lower member 224 is generally planar and is configured to lie against a bottom sheet of the stack of sheets 108 when bound. The upper and lower members 220, 224 are spaced apart a predetermined distance by the temporary connectors 228 to define a stack insertion gap G (FIG. 7). More specifically, the upper member 220 includes an inner surface 232, and the lower member 224 includes an inner surface 236 facing the inner surface 232 of the upper member 220, the distance between the inner surfaces 232, 236 defining the stack insertion gap G.

The upper member 220 includes an outer surface 240 opposite its inner surface 232. Three recesses 244 are formed in the outer surface 240 corresponding to the three stapling heads 116. One will appreciate that the number of stapling heads 116 is easily variable, and certain other features, including features of the binding machine 100 and the binding spine 104 are variable relative to the number of stapling heads 116. Each recess 244 is relieved from the outer surface 240 a small depth to accommodate the crown C of a staple 180 (FIG. 13). The lower member 224 includes an outer surface 248 in which three pairs of recesses 252 (FIG. 14) are formed. The recesses 252 in the outer surface 248 of the lower member 224 are configured to accommodate the anvil blocks 208 during the binding operation and are configured to accommodate individual bent portions of the legs L of respective staples 180 once bound (FIG. 14). The upper member 220 and the lower member 224 further include respective apertures 256, 260 that extend through the upper and lower members 220, 224 at the respective recesses 244, 252. The apertures 256, 260 are configured to be aligned with the unbent legs L of the staples 180 when the binding spine 104 is positioned in the binding machine 100 so that there is substantially no extra force required to drive the staples 180 through the binding spine 104 as compared to merely binding the stack of sheets 108 without the binding spine 104. Recessing the crown C and the bent legs L of the staples 180 in the recesses 244, 252 provides not only a clean, finished look, but also prevents the crown C and the bent legs L from protruding outwardly from the respective outer surfaces 240, 248 of the spine members 220, 224. This prevents undesirable surface irregularity and potential snagging that may otherwise occur.

The illustrated temporary connectors 228 are generally semi-cylindrical in shape, each having a generally open C-shaped cross-section. Each of the temporary connectors 228 constitutes a female member configured to receive a corresponding one of the posts 216 of the binding machine 100. Thus, the temporary connectors 228, in addition to coupling and spacing the upper and lower members 220, 224, are alignment features that correspond with the alignment features (i.e., posts 216 and support blocks 217) of the binding machine 100 to positively position the binding spine 104 in the binding machine 100 in a predetermined orientation relative to the binding machine 100.

The temporary connectors 228 are weakly connected to both the upper member 220 and the lower member 224 at predetermined breaking locations 264. As shown in FIGS. 5 and 8, each temporary connector 228 is connected to the upper and lower members 220, 224 at only one side where the generally C-shaped cross-section meets the upper and lower members 220, 224. In alternate constructions, each temporary connector 228 has connections with the upper and lower members 220, 224 defining predetermined breaking locations 264 on both sides of the generally C-shaped cross-section. As described in further detail below, the predetermined breaking locations 264 enable the upper and lower members 220, 224 to assume a different spacing, smaller than the stack insertion gap G, in order to clamp the stack of sheets 108 therebetween. The binding spine 104, which may be unitarily molded as a single plastic piece, is formed such that a very small amount of material connects the temporary connectors 228 to each of the upper and lower members 220, 224. As such, the connection strength is great enough to hold the upper and lower members 220, 224 apart, but low enough that the connections are easily broken during operation of the binding machine 100. In some constructions, specifically-designed break-inducing features (notches, perforations, etc.) may be incorporated at the predetermined breaking locations 264.

Furthermore, the temporary connectors 228 each include a pair of contact surfaces 268 configured to contact the edge 148 of the stack of sheets 108 that is to be bound. The contact surfaces 268 of the temporary connectors 228 define a sheet edge guide that aligns each of a plurality of sheets within the stack of sheets 108 along the edge 148 to be bound.

In operation, the magazines 172 of the three stapling heads 116 are filled with strips of staples 180. The stapling heads 116 are rotated up from the base 112, and the binding spine 104 is inserted into the binding machine 100. During insertion of the binding spine 104 into the binding machine 100, the alignment features of the binding spine 104 are engaged with the alignment features of the binding machine 100 to positively position the binding spine 104 relative to the binding machine 100. Namely, in the illustrated construction, the temporary connectors 228 are placed over the posts 216, limiting any side-to-side or front-to-back movement of the binding spine 104 relative to the binding machine 100. This ensures that the positions of the recesses 244, 252 and the apertures 256, 260 of the upper and lower members 220, 224 are in proper registration with the stapling heads 116 for proper binding. The temporary connectors 228 rest atop the upper surfaces 218 of the support blocks 217 to fix the vertical position of the binding spine 104 relative to the binding machine 100. Both the upper member 220 and the lower member 224 are cantilevered from the temporary connectors 228.

Once the binding spine 104 is positively positioned relative to the binding machine 100, the stapling heads 116 are returned to the positions shown in FIGS. 1-4, 9, and 10, and the stack of sheets 108 is inserted into the binding machine 100 such that the edge 148 to be bound is positioned in the throat area 128 (FIGS. 9 and 10). The stack of sheets 108 is positively positioned relative to the binding spine 104 and the binding machine 100 by contact with the contact surface 140 of the paper guide 136 and by contact with the contact surfaces 268 of the temporary connectors 228. As described above, the stack of sheets 108 may be compressed between the support surface 120 and the upper wing 152. The thickness of the stack of sheets 108 (and thus the maximum number of sheets) is limited by the upper wing 152. In some constructions, the maximum stack thickness is related to the maximum performance of the stapling heads 116. Thus, in some constructions, the height of the upper wing 152 above the support surface 120 is greater or less than illustrated. In still other constructions, there is no upper wing 152, and the maximum stack thickness is only limited by the stack insertion gap G of the binding spine 104.

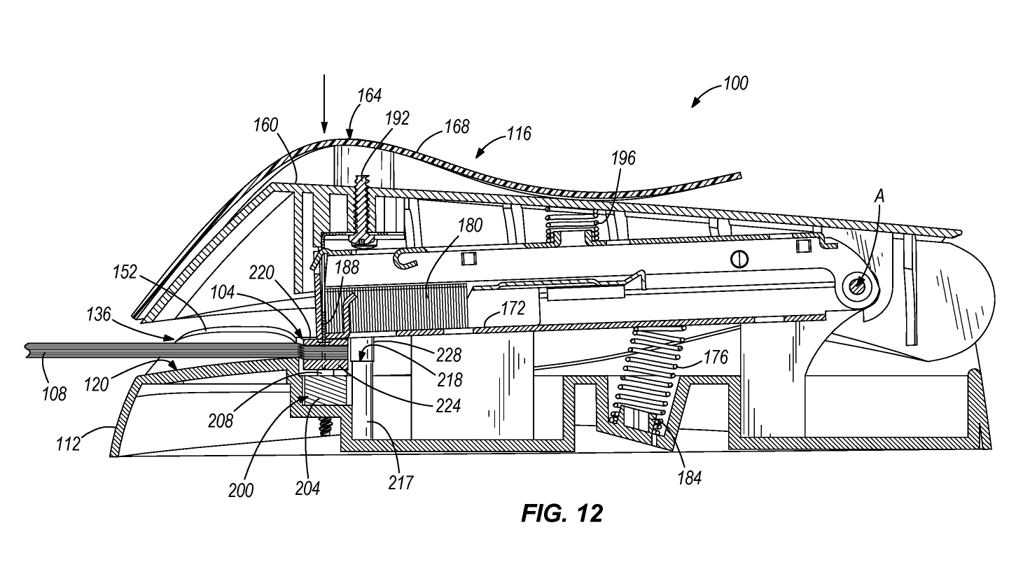

With the stack of sheets 108 positively positioned relative to the binding machine 100 and the binding spine 104, the stapling heads 116 are operated to bind the stack of sheets 108. The binding operation includes separating the upper and lower members 220, 224 from each other and from the temporary connectors 228, clamping the stack of sheets 108 between the upper and lower members 220, 224, and inserting a binding element (i.e., staples 180) through the stack of sheets 108 and at least partially through each of the upper and lower members 220, 224. The binding operation is illustrated in FIGS. 11A-12 and described in greater detail below.

In the first stage of the binding operation, as shown in FIG. 11A, the input member 160 is depressed to rotate downwardly towards the base 112 about the pivot axis A. The magazine 172 moves with the input member 160 to compress the first spring 176 as the second spring 196 remains substantially uncompressed. Movement of the magazine 172 into contact with the outer surface 240 of the upper member 220 causes the upper member 220, which is initially cantilevered from the temporary connectors 228 to break apart from the temporary connectors 228 at the predetermined breaking locations 264. The temporary connectors 228 are supported from below by the upper surfaces 218 of the support blocks 217 and remain stationary as the upper member 220 is severed.

Once the upper member 220 of the binding spine 104 is severed from the temporary connectors 228, continued downward force on the input member 160 brings the inner surface 232 of the upper member 220 into contact with the top of the stack of sheets 108 as the magazine 172 is moved further against the bias of the first spring 176 as shown in FIG. 11 B. Once the upper member 220 is brought into contact with the top of the stack of sheets 108, the force brought upon the binding spine 104 by the magazine 172 is transferred through the stack of sheets 108 to the lower member 224, which is also initially cantilevered from the temporary connectors 228.

The downward force from the input member 160, transferred through the second spring 196 to the magazine 172 and now incident on the lower member 224, causes the lower member 224 to break apart from the temporary connectors 228 at the remaining predetermined breaking locations 264. Once the lower member 224 is severed from the temporary connectors 228 as shown in FIG. 11B, the lower member 224 moves downward into contact with the anvil blocks 208, which support the upper and lower members 220, 224 and the corresponding portion of the stack of sheets 108 therebetween. The anvil blocks 208 are at least partially received into the recesses 252 as the uppermost surfaces of the anvil blocks 208 contact the surface portions that are recessed from the outer surface 248 of the lower member 224. Prior to breaking the lower member 224 from the temporary connectors 228, the binding spine 104 is held above the anvils 200 (i.e., cantilevered as described above), and the lower member 224 drops a short distance (i.e., about 0.030 inches) before making contact with the anvil blocks 208.

At this point, when both the upper and lower members 220, 224 have been severed from the temporary connectors 228 and support is provided from below by the anvil blocks 208, the input force tends to clamp the stack of sheets 108 tightly between the upper and lower members 220, 224. Thus, a distance or final gap G′ (FIG. 14) between the inner surfaces 232, 236 of the upper and lower members 220, 224 is achieved. The final gap G′ is substantially equal to the thickness of the stack of sheets 108. In this manner, the binding spine 104 is customized from the predetermined stack insertion gap G, which does not match the thickness of the stack of sheets 108 to the final gap G′, which exactly matches the thickness of the stack of sheets 108. With the stack of sheets 108 tightly clamped between the upper and lower members 220, 224, which are free from the temporary connectors 228, the binding spine 104 and the stack of sheets 108 are ready to be bound.

As shown in FIG. 12, further downward force on the input member 160 causes the input member 160 to move relative to the magazine 172 such that the driver blade 188 drives a staple 180 out of the magazine 172. The staple legs L pass through the apertures 256 in the upper member 220 with little or no resistance before being forcibly driven through all of the sheets in the stack 108. Upon penetrating the bottommost sheet in the stack 108, the staple legs L pass through the apertures 260 with little or no resistance before contacting the curved anvil surfaces 212 of the anvil blocks 208, which bend the staple legs L inward towards each other. Once the staple 180 is clinched, the input force may be released, and the first and second springs 176, 196 return the input member 160 and the magazine 172 to their original positions. The use of staples 180 and stapling heads 116 eliminates the need for pre-punching holes into the stack of sheets 108. Binding the stack of sheets 108 is completed when all of the stapling heads 116 have been operated to break the binding spine 104 at the predetermined breaking locations 264 and drive staples 180 into the binding spine 104 and the stack of sheets 108.

The stack of sheets 108, which is now bound between the upper and lower members 220, 224 is removed from the binding machine 100. The crowns C of the staples 180 are neatly recessed from the outer surface 240 of the upper member 220 (FIG. 13), and the legs L of the staples 180 are neatly recessed from the outer surface 248 of the lower member 224 (FIG. 14). If the thickness of the stack of sheets 108 is sufficiently small, the legs L of the staples 180 may penetrate into a strip of material 280 (FIG. 14) located between each pair of recesses 252 so that the chance of the staples 180 becoming loosened is reduced.

The temporary connectors 228 are retained on the binding machine 100 by the posts 216 and later removed and discarded by the user. Alternately, the severed temporary connectors 228 fall away from the posts 216 and off of the support blocks 217 and are stored inside the binding machine 100 until discarded at a later time.

The full operation of one of the stapling heads 116 is described above. It will be understood that each of the stapling heads 116 operates in substantially the same manner, and that the stapling heads 116 may be operated either sequentially or synchronously.

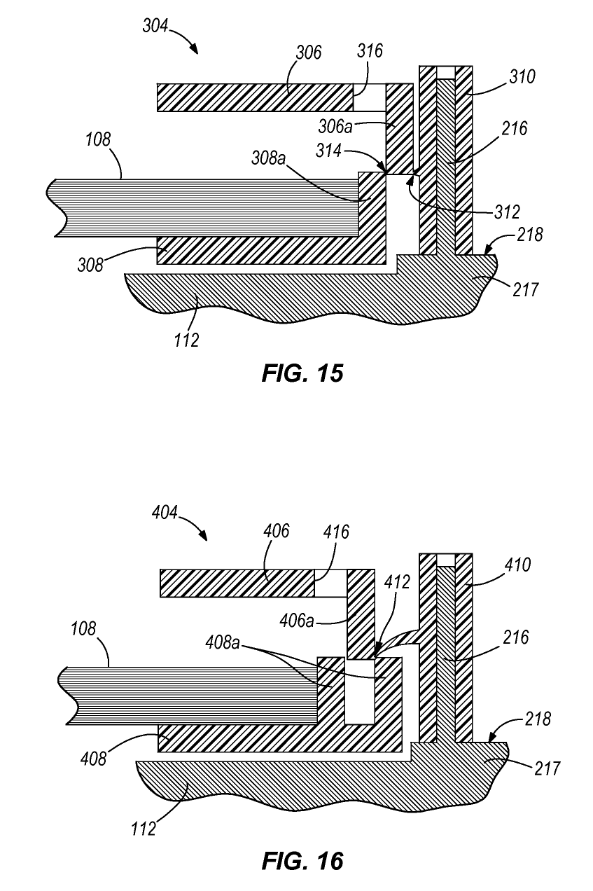

FIG. 15 illustrates a binding spine 304 of an alternate construction. The binding spine 304 includes upper and lower members 306, 308 and temporary connectors 310 (one shown). The binding spine 304 of FIG. 15 is similar to the binding spine 104 described above except as noted below. At each temporary connector 310, the binding spine 304 includes a first predetermined breaking location 312 between the upper member 306 and the temporary connector 310 and a second separate predetermined breaking location 314 between the upper member 306 and the lower member 308. Each of the upper and lower members 306, 308 are generally L-shaped rather than being generally planar, the vertical portions 306a, 308a of the upper and lower members 306, 308 being offset in cross-section. The vertical portion 308a of the lower member 308 forms a sheet edge guide for aligning the edge 148 of the stack of sheets 108 to be bound. Downward pressure on the upper member 306 causes the binding spine 304 to break at the first and second predetermined breaking locations 312, 314. The vertical portions 306a, 308a overlap each other when the stack of sheets 108 is bound. The upper member 306 includes an opening 316 through which the vertical portion 308a of the lower member 308 extends if the stack of sheets 108 is sufficiently small.

FIG. 16 illustrates a binding spine 404 of an alternate construction. The binding spine 404 includes upper and lower members 406, 408 and temporary connectors 410 therebetween (one shown). The binding spine 404 of FIG. 16 is similar to the binding spine 104 described above except as noted below. At each temporary connector 410, the binding spine 404 includes a single predetermined breaking location 412 between the upper member 406 and the lower member 408. The upper member 406 is generally L-shaped rather than being generally planar, and the lower member 408 is generally F-shaped. The vertical portion 406a of the upper member 406 is offset with the vertical portions 408a of the lower members 408 so that the vertical portion 406a of the upper member 406 may extend between the vertical portions 408a of the lower member 408. The vertical portion 408a of the lower member 408 nearest the stack of sheets 108 forms a sheet edge guide for aligning the edge 148 of the stack of sheets 108 to be bound. Downward pressure on the upper member 406 causes the binding spine 404 to break at the single predetermined breaking location 412, which severs the connection between the upper and lower members 406, 408. Because a single connection joins the upper and lower members 406, 408 and the temporary connector 410, severing this single connection simultaneously breaks the upper and lower members 406, 408 from each other and from the temporary connector 410 at a single location. The vertical portions 406a, 408a overlap each other when the stack of sheets 108 is bound. The upper member 406 includes an opening 416 through which the inner vertical portion 408a of the lower member 408 extends if the stack of sheets 108 is sufficiently small.

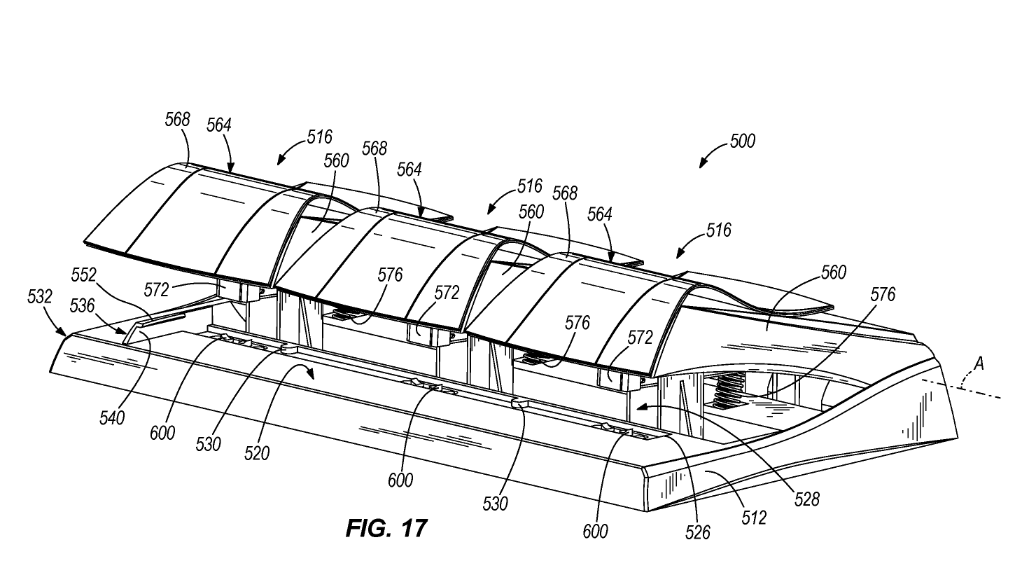

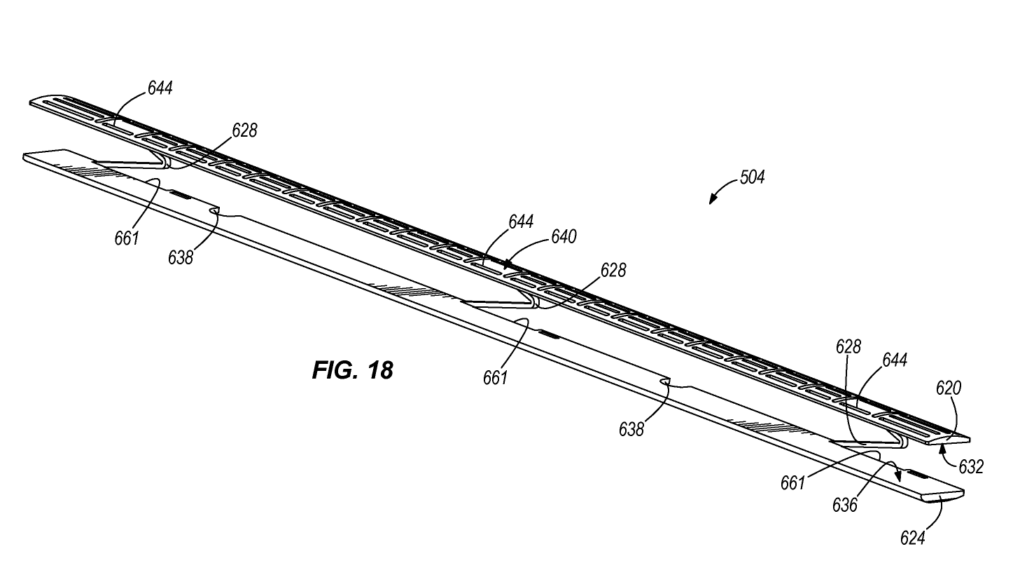

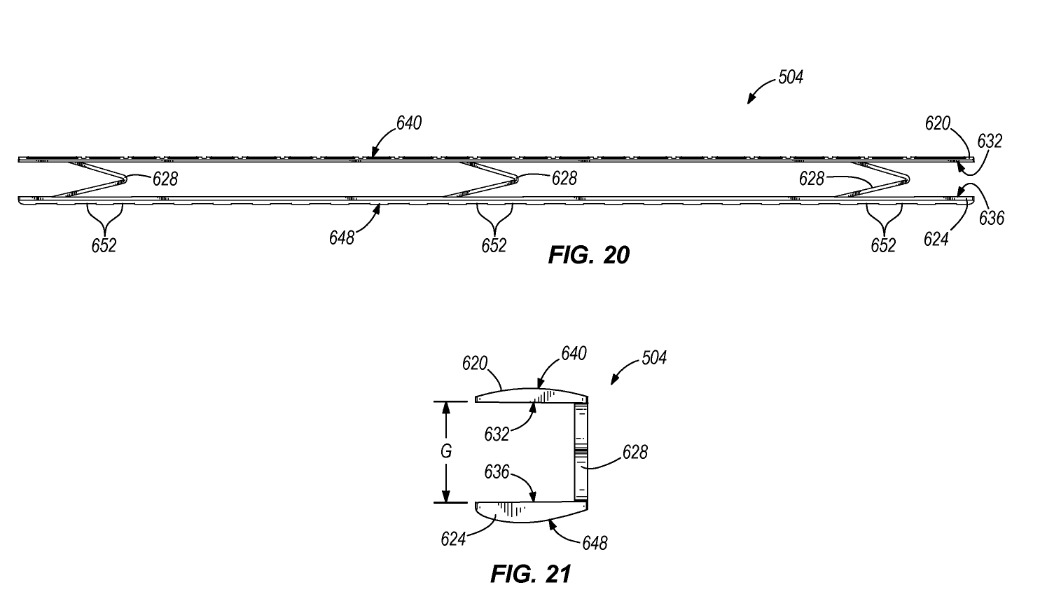

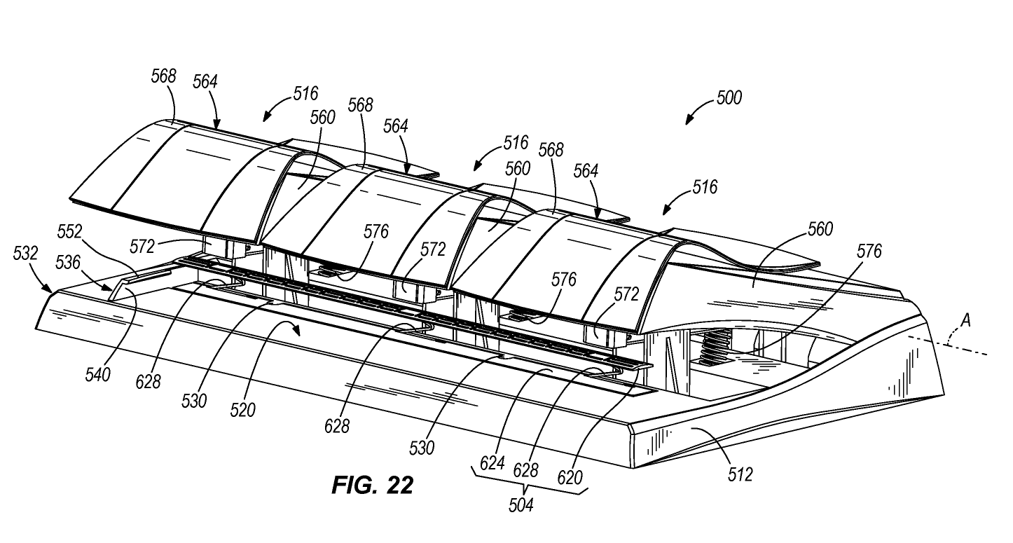

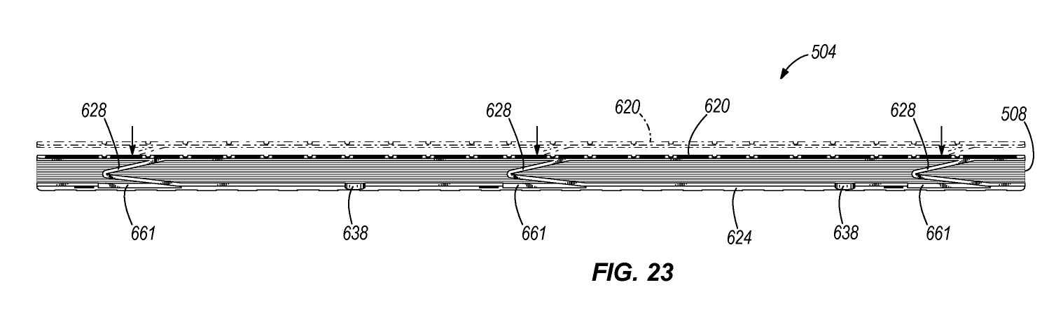

FIGS. 17 and 22 illustrate a binding machine 500 for use with a binding spine 504 (FIGS. 18-23) to bind a stack of sheets 508 (FIG. 23). The binding machine 500 includes a base 512 and a plurality of binding units (i.e., stapling heads 516), each pivotably coupled to the base 512. With the exception of the particular differences described below, the binding machine 500 of FIGS. 17 and 22 is similar to the binding machine 100 described in detail above and reference is hereby made to the above description. Where applicable, reference numbers have been carried over from the above description, although taken from the 500 and 600 series rather than the 100 and 200 series.

The base 512 of the binding machine 500 includes a support surface 520 configured to support a stack of sheets (of paper or another material) that are to be bound. The illustrated support surface 120 is substantially flat and positioned adjacent a throat area 528 of the binding machine 500. A cavity or recess 526 is formed in the base 512 to receive the binding spine 504 as shown in FIG. 22. An anvil 600 corresponding to each one of the stapling heads 516 is positioned within the recess 526 as shown in FIG. 17. The anvils 600 are similar to the anvils 200 of the binding machine 100 described above and are configured to engage the legs of staples that are ejected from the respective stapling heads 516 and driven through the stack of sheets 508 and the binding spine 504. At least one projection 530 protrudes into the recess 526 to engage the binding spine 504 as described below. The at least one projection 530 (two projections 530 in the illustrated construction) is/are asymmetrically positioned along the length of the recess 526. The recess 526 and the projections 530 constitute alignment features that positively position the binding spine 504 in the binding machine 500.

The binding spine 504 is described with particular reference to FIGS. 18-21. The binding spine 504 includes a first member (“upper member 620”), a second member (“the lower member 624”), and three connectors 628. The upper member 620 is generally planar and is configured to lie against a top sheet of the stack of sheets 508 when bound. The lower member 624 is generally planar and is configured to lie against a bottom sheet of the stack of sheets 508 when bound. The upper and lower members 620, 624 are spaced apart a predetermined distance by the connectors 628 to define a stack insertion gap G (FIG. 21). More specifically, the upper member 620 includes an inner surface 632, and the lower member 624 includes an inner surface 636 facing the inner surface 632 of the upper member 620, the distance between the inner surfaces 632, 636 defining the stack insertion gap G.

As illustrated, the connectors 628 are integral with both the upper and lower members 620, 624 such that the entire spine 504 may be formed as a single, unitary piece (e.g., molded from plastic in a single molding operation). Alternately, the spine 504 can be constructed of two or more separately-formed components that are assembled together. The connectors 628 can be formed separately from both the upper and lower members 620, 624 in some embodiments. In other embodiments, the connectors 628 can be formed with either one of the upper and lower members 620, 624 while being separate from the other of the upper and lower members 620, 624. In still other embodiments, the upper and lower members 620, 624 may each be formed with portions of the connectors 628. If two or more separately-formed components are used to construct the spine 504, the components can be configured to snap together to function similarly to a unitarily-formed spine 504. In some embodiments, the spine 504 is constructed of a material other than plastic, such as heavy paper (e.g., card stock, cardboard, etc.) or any other material suitable for binding a stack of sheets.

The lower member 624 includes at least one recess 638 corresponding in number and placement to the projections 530 in the recess 526 of the base 512. In the illustrated construction, there are two projections 530 and two corresponding recesses 638. Like the projections 530, the recesses 638 are asymmetrically positioned along the length of the binding spine 504. The projections 530 engage the recesses 638 when the binding spine 504 is properly positioned within the binding machine 500 (FIG. 22) and prevent the binding spine 504 from dropping into the recess 526 when improperly oriented relative to the binding machine 500.

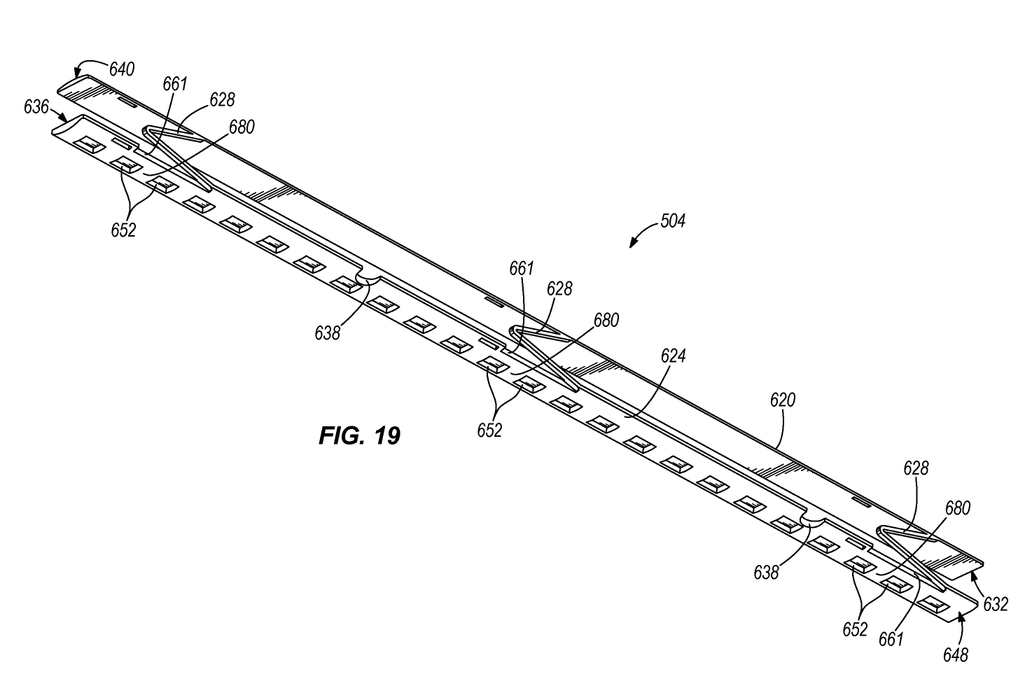

The upper member 620 includes an outer surface 640 opposite its inner surface 632. Recesses 644 are formed in the outer surface 640, each recessed a small depth to accommodate the crown of a staple. The recesses 644 may or may not include apertures similar to the apertures 256 (FIG. 5) in the binding spine 104 described above. When no apertures are included, the staple legs must pierce through the upper member 620, but alignment between the binding spine 504 and the binding machine 500 is less critical. The lower member 624 includes an outer surface 648. A plurality of recesses 652 (FIG. 19) are formed in the lower member 624 to define a plurality of reduced-thickness portions of the lower member 624. The recesses 652 in the lower member 624 are configured to accommodate the respective blocks of the anvil 600 when the binding spine 504 is positioned in the recess 526. Between any given pair of recesses 652, a strip of material 680 is formed. The strips 680 can receive and embed staple legs penetrated therein during clinching by the anvils 600 if the stack of sheets is substantially small. The upper member 620 and the lower member 624 include a plurality of additional recesses (unnumbered, but illustrated) similar to the recesses 644, 652, enabling the binding spine 504 to be used with binding machines having various alternate numbers and/or configurations of stapling heads and anvils.

Unlike the temporary connectors 228 of the binding spine 104 described above, the integrated connectors 628 are not configured to break away from either of the upper or lower member 620, 624 of the binding spine 504. Rather, the integrated connectors 628 are configured to collapse by flexing and/or compressing as the upper and lower members 620, 624 are moved toward each other during the binding operation. In the illustrated construction, the integrated connectors 628 are configured to allow the upper and lower members 620, 624 to collapse together with substantially no transverse movement. FIG. 23 illustrates the integrated connectors 628 compressing to allow the binding spine 504 to collapse under force from the binding machine 500 (not shown in FIG. 23) from the predetermined stack insertion gap to match the thickness of the stack 508. The illustrated integrated connectors 628 are substantially V-shaped with two flexible legs, but other shapes are optional, such as multiple consecutive V's in an “accordion” configuration. Because the integrated connectors 628 fold rather than break off, there is no waste material created from the binding operation.

Recesses or cutouts 661 are formed in the lower member 624 of the binding spine 504 to allow the integrated connectors 628 to nest therein when a stack of sheets with a very small thickness is bound with the binding spine 504. Thus, the integrated connectors 628 do not interfere with the ability of the binding spine 504 to collapse because the connectors 628 do not actually lie between the interior surfaces 632, 636 due to the interior surface 636 of the lower member 624 terminating at the respective cutouts 661. The cutouts 661 further enable the integrated connectors 628 to remain intact with the spine-bound product without extending or projecting any further outward from the bound edge than either of the upper and lower members 620, 624.

Furthermore, the integrated connectors 628 each define contact surfaces configured to contact the edge of the stack of sheets 508 to be bound. Thus, the integrated connectors 628 define a sheet edge guide that aligns each of a plurality of sheets within the stack of sheets 508 along the edge to be bound.

Thus, the invention provides, among other things, a binding system including a binding machine and a binding spine for binding stacks of sheets with staples. The binding spines are reliably positioned in the binding machine, and the sheets are reliably positioned in the binding spine. The binding spine is initially oversized for the thickness of the stack of sheets and is configured to automatically match the thickness of the stack of sheets during binding without the need for dedicated input in doing so. Thus, a single type of binding spine is usable to bind stacks of sheets having various thicknesses, all with the same result, which is a tight and neat binding of the stack. The use of stapling heads and staples eliminates any separate sheet punching operation, thereby simplifying the binding machine and the binding process, and reducing or eliminating waste. Various features and advantages of the invention are set forth in the following claims.

What is claimed is:

1. A binding spine for binding together stacks of sheets, the binding spine comprising:
a first member;
a second member spaced from the first member; and
a connector connecting the first member and the second member to define a preliminary stack insertion gap therebetween prior to binding,
the connector allowing the first member and the second member to be collapsed toward each other to define a final gap therebetween that is less than the preliminary stack insertion gap.

2. The binding spine of claim 1, wherein the connector includes a contact surface defining a sheet edge guide aligning each of a plurality of sheets within the stack of sheets along an edge to be bound.

3. The binding spine of claim 1, further comprising an alignment feature positively positioning the binding spine within a binding machine.

4. The binding spine of claim 1, wherein each of the first member and the second member have an inner surface and an outer surface, the respective inner surfaces facing each other, wherein the first member is configured to receive a crown of a staple, the crown being recessed from the outer surface of the first member, and the second member is configured to receive legs of the staple, the legs being recessed from the outer surface of the second member.

5. The binding spine of claim 4, wherein the first member includes a first recess for receiving the crown of the staple, and the second member includes two separate recesses for receiving the legs of the staple.

6. The binding spine of claim 1, wherein the first member, the second member, and the connector are unitarily-formed as a single piece.

7. The binding spine of claim 1, wherein the connector is one of a collapsible connector and a severable connector.

8. The binding spine of claim 7, wherein the connector is a collapsible connector and includes flexible legs foldable upon themselves to allow the first member and the second member to collapse directly toward each other with substantially no transverse movement.

9. The binding spine of claim 7, wherein the connector is a severable connector and includes at least one predetermined breaking location at which the connector is separable from the first member and the second member during operation of the binding machine.

10. The binding spine of claim 1, wherein the connector is one of a plurality of similar connectors.

11. A binding spine for binding together stacks of sheets, the binding spine comprising:
a first member;
a second member spaced from the first member; and
a collapsible connector adjustably connecting the first member and the second member,
wherein the collapsible connector biases the binding spine to a first configuration in which the first member and the second member are spaced a first distance apart to define a preliminary stack insertion gap therebetween prior to binding,
the collapsible connector being deformable such that the binding spine assumes a second configuration in which the first member and the second member are spaced apart a second distance after binding to define a final gap therebetween that is less than the preliminary stack insertion gap.

12. The binding spine of claim 11, further comprising a sheet edge guide configured to align each of a plurality of sheets within the stack of sheets along an edge to be bound.

13. The binding spine of claim 12, wherein the sheet edge guide includes a contact surface of the collapsible connector configured to align each of the plurality of sheets along the edge to be bound.

14. The binding spine of claim 11, wherein the binding spine is unitarily-formed as a single piece.

15. The binding spine of claim 11, further comprising an alignment feature configured to positively position the binding spine within a binding machine.

16. The binding spine of claim 11, wherein each of the first member and the second member have an inner surface and an outer surface, the respective inner surfaces facing each other, wherein the first member is configured to receive a crown of a staple, the crown being recessed from the outer surface of the first member, and the second member is configured to receive legs of the staple, the legs being recessed from the outer surface of the second member.

17. The binding spine of claim 16, wherein the first member includes a first recess for receiving the crown of the staple, and the second member includes two separate recesses for receiving the legs of the staple.

18. The binding spine of claim 11, wherein the collapsible connector includes flexible legs foldable upon themselves to allow the first member and the second member to collapse directly toward each other with substantially no transverse movement.

19. A method of binding a stack of sheets with a binding spine, the method comprising:
providing a binding spine including a first member, a second member, the first and second members being interconnected by a connector;
providing a predetermined stack insertion gap between the first member and the second member with the connector;
inserting a stack of sheets into the stack insertion gap;
collapsing the first member and the second member toward each other;
clamping the stack of sheets between the first member and the second member; and
inserting a binding element through the stack of sheets and at least partially through each of the first member and the second member to bind the stack of sheets in the binding spine.

20. The method of claim 19, wherein the binding element includes a staple, and the method further comprises driving the staple through the binding spine and through the stack of sheets such that a crown of the staple lies against an outer surface of the first member and legs of the staple engage the second member.

21. The method of claim 19, further comprising positively positioning the stack of sheets relative to the binding spine with a contact surface of the connector.

22. The method of claim 19, further comprising positively positioning the binding spine relative to the binding machine.

23. The method of claim 19, wherein the connector is a collapsible connector, the method further comprising folding the collapsible connector upon itself during the collapsing of the first member and the second member to reduce the spacing therebetween.

24. The method of claim 19, wherein the connector is a temporary connector, the method further comprising severing the temporary connector from the first member and the second member during clamping.

25-30. (canceled)
